(19) United States
(12) Patent Application Publication
(10) Pub. No.: US 2011/0018909 A1
(43) Pub. Date: Jan. 27, 2011

(54) IMAGE DISPLAY WITH FUNCTION FOR TRANSMITTING LIGHT FROM SUBJECT TO BE OBSERVED

(75) Inventors: Kaoru OTA, Tokyo (JP); Satoshi NIIYAMA, Tokyo (JP); Remi KAWAKAMI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY LIMITED, Chiyoda-ku (JP)

(21) Appl. No.: 12/885,022

(22) Filed: Sep. 17, 2010

Related U.S. Application Data
(63) Continuation of application No. PCT/JP09/55482, filed on Mar. 19, 2009.

(30) Foreign Application Priority Data
Mar. 19, 2008 (JP) 2008-071614

(51) Int. Cl. G09G 5/10; G09G 5/00

(52) U.S. Cl. 345/690; 345/204

(57) ABSTRACT

The present invention relates to an image display with a function for transmitting light from a subject to be observed, the image display including: a display element which includes a pair of transparent substrates with electrodes and a liquid crystal layer which is sandwiched between the pair of substrates with electrodes and is capable of being in a light transmitting state and a light scattering state, the display element being brought into the light transmitting state when no voltage is applied and being brought into the light scattering state when a voltage is applied; a light source which inputs light substantially parallel with a surface of the liquid crystal layer into the liquid crystal layer; and a timing control circuit which brings at least a part of a display surface of the display element into the light scattering state or the light transmitting state in conjunction with the state of light emission into the liquid crystal layer of the light source in the presence of external light.

### TECHNICAL FIELD

The present invention relates to an image display with a function for transmitting light from a subject to be observed, which enables an observer to view a subject to be observed located on the rear side of a display element through the display element and which can display information provided to the observer.

### BACKGROUND ART

As a finder device for a camera, a finder device including a dispersion (diffusion) liquid crystal display panel is known (for example, see Patent Documents 1 and 2). FIG. 14 is a sectional view showing a part of a camera including a finder device described in Patent Documents 1 and 2. As shown in FIG. 14, a mirror 311 is provided inside a camera main body 300 to reflect external light input through a lens 321 provided in a lens barrel 320. The optical path of light reflected by the mirror 311 is changed by a prism 313 and reaches outside a see-through window 315 through an eye lens 314.

Inside the camera main body 300, a liquid crystal display panel 312 driven by a drive circuit 316 is provided in the course of the optical path of light reflected by the mirror 311. The liquid crystal display panel 312 is configured such that a liquid crystal element is sandwiched between a pair of transparent substrates with electrodes. The liquid crystal display panel 312 is brought into a light transmitting state when a voltage is applied between the substrates, and is brought into a light scattering state when no voltage is applied.

A photographer who photographs a subject to be observed by using a camera performs photographing while looking through the see-through window 315. The photographer operates a switch (not shown) provided in the camera main body 300 so as to perform mode setting. A CPU (not shown) provided in the camera main body 300 controls the drive circuit 316 in accordance with a set mode such that a voltage is not applied between electrodes in a predetermined display target area of the liquid crystal display panel 312. As a result, as illustrated in an explanatory view of FIG. 15, a predetermined mark is displayed in the display target area. FIG. 15 shows an example where a mark 310 indicating a focus area is displayed. In an area other than the display area of the mark 310 of the liquid crystal display panel 312, a voltage is continuously applied, and the liquid crystal display panel 312 is in the light transmitting state. Therefore, the photographer can view the subject to be observed and the mark 310 from the see-through window 315.

Patent Document 1: JP-A-2004-212792

Patent Document 2: JP-A-2000-75393

### DISCLOSURE OF INVENTION

### Problems that the Invention is to Solve

However, the finder device using the above-described liquid crystal display panel 312 has the following problems. First, it is necessary to apply a voltage between the substrates so as to bring the liquid crystal display panel 312 into the light transmitting state, causing an increase in power consumption of the camera. In general, since an electrical circuit provided in the camera is driven by a battery, the available period of the battery is shortened. Further, when a camera which is provided with the finder device using the above-described liquid crystal display panel 312 is displayed at the front of a store such that a user can access the camera, if the camera is powered on, the battery runs down. For this reason, the camera is displayed in a state of being powered-off. When this happens, when the user looks through the see-through window 315 of the camera, the user may view nothing and may distrust the quality of the camera.

In the liquid crystal display panel 312, electrodes (in the example of FIG. 15, respective sides of a substantial rectangle indicating a focus area) for mark display are provided in a portion where the mark 310 is displayed, and a wiring pattern is provided to be connected to the electrodes for mark display from the edge of the liquid crystal display panel 312. Thus, when voltage application to the electrodes for mark display is stopped, and the area for mark display is brought into the light scattering state, the area of the wiring pattern is also brought into the light scattering state and viewed. That is, the display surface of the image display has a bad appearance. In FIG. 15, a portion indicated by a broken line indicates a wiring pattern.

Accordingly, an object of the invention is to provide an image display with a function for transmitting light from a subject to be observed (hereinafter, referred to as a light transmitting function) which can reduce power consumption and has a good appearance of a display surface.

### Means for Solving the Problems

An image display with a function for transmitting light from a subject to be observed according to the invention includes: a display element which includes a pair of transparent substrates with electrodes, and a liquid crystal layer which is sandwiched between the pair of substrates with electrodes and is capable of being in a light transmitting state and a light scattering state, the display element being brought into the light transmitting state when no voltage is applied and being brought into the light scattering state when a voltage is applied; a light source which inputs light substantially parallel with the surface of the liquid crystal layer (including light completely parallel with the surface of the liquid crystal layer) into the liquid crystal layer; and a timing control circuit which brings at least a part of the display surface of the display element into the light scattering state or the light transmitting state in conjunction with the state of light emission into the liquid crystal layer of the light source in the presence of external light.

The light source may produce one light source color and a frame frequency thereof may be equal to or greater than 15 Hz.

If the light source color is red, a specific display portion of the display element is brought into the light scattering state in conjunction with light emission, and the portion becomes a display color of red, improving visibility for the observer.

The light source may produce one light source color, the frame frequency of the light source color may be equal to or greater than 15 Hz, the ratio of a light emission period in one frame may be equal to or smaller than ⅓, and the timing control circuit may bring at least a part of the display surface of the display element into the light scattering state in conjunction with a light non-emission period. Thus, the light non-emission period can be sufficiently secured, and a good display color according to external light can be obtained. For the use of an optical system in which at least a part of external light is blocked by the portion in the light scattering state, such as a finder for a single-lens reflex camera, in the light non-emission period, a period in which a specific portion of the display element is in the light scattering state is adjusted, such that halftone display can be carried out from perfect black display to light-black. As a result, visibility for the observer can be improved, and expressive display can be carried out on the display surface.

The light source may sequentially produce two or more light source colors, the frame frequency of each light source color may be equal to or greater than 15 Hz, and the timing control circuit brings at least a part of the display surface of the display element into the light scattering state or the light transmitting state in conjunction with the state of light emission of one light source color or a plurality of light source colors to obtain a display color according to one light source color or a plurality of light source colors.

The light source can produce, for example, red, blue, and green individually. The image display may include, at different display timing in a single display portion, display in which the display color is a single color and display in which the display color is multi-color.

It is preferable that a light guide portion be provided between the light source and the display element to spread light emitted from the light source from one end to the other end at the lateral part of the liquid crystal layer.

It is preferable that the frame frequency of the light source color is equal to or greater than 30 Hz.

The image display with a function for transmitting light from a subject to be observed according to the invention can be applied to, for example, a finder device for a camera, an optical microscope, and binoculars.

### ADVANTAGEOUS EFFECTS

According to the invention, it is possible to provide an image display with a function for transmitting light from a subject to be observed, which can reduce power consumption and has a good appearance of a display surface.

### BRIEF DESCRIPTION OF DRAWINGS

FIG. 1 is a schematic exterior view showing an image display according to the invention.

FIG. 2 is a schematic sectional view showing a display element according to the invention.

FIGS. 3(a) to 3(e) are explanatory views illustrating a curable compound which can be used in a display element.

FIG. 4 is a schematic sectional view showing an application example of an image display according to the invention.

FIG. 5 is an explanatory view showing a display example in an image display.

FIG. 6 is a schematic view showing the relationship between drive of a display element in an image display and a light source.

FIG. 7 is a block diagram showing a configuration example of a drive circuit for driving a display element.

FIG. 8 is a schematic view showing the relationship between drive of a display element in an image display and a light source.

FIG. 9 is a schematic view showing the relationship between drive of a display element in an image display and a light source.

FIG. 10 is a schematic view showing the relationship between drive of a display element in an image display and a light source.

FIGS. 11(A) to 11(C) are explanatory views illustrating the configuration and operation of an image display when a single light source is used.

FIGS. 12(A) to 12(F) are explanatory views illustrating the effect of a light guide portion.

FIGS. 13(A) and 13(B) are explanatory views showing display examples of respective examples and a comparative example.

FIG. 14 is a schematic sectional view showing a part of a camera including a finder device.

FIG. 15 is an explanatory view showing a display example in the background art.

FIG. 16 is a block diagram showing another configuration example of a drive circuit for driving a display element.

FIG. 17 is a schematic view showing the relationship between drive of a display element in an image display and a light source.

FIG. 18 is a schematic view showing the relationship between drive of a display element in an image display and a light source.

FIG. 19 is a schematic view showing the relationship between drive of a display element in an image display and a light source.

### DESCRIPTION OF REFERENCE NUMERALS AND SIGNS

1: display element
2: light source
3: observer
4: light guide portion
7, 8, 9: mark (display portion)
10: image display
20: drive circuit
22: light source
41: optical fiber
101, 108: glass substrate
102, 107: transparent electrode
103, 106: alignment film
104: liquid crystal layer
105: seal layer
201: timing control circuit
202: voltage generating circuit
203: electrode drive circuit
204: electrode drive circuit
205: temperature sensor
300: camera main body
311: mirror
312: liquid crystal display panel
313: prism
314: eye lens
315: see-through window
316: drive circuit
320: lens barrel
321: lens

### BEST MODE FOR CARRYING OUT THE INVENTION

Hereinafter, an embodiment of the invention will be described with reference to the drawings. First, a display method which is used in an image display according to the invention will be described. In the image display according to the invention, a field sequential color method is used in which color display is obtained by combining a liquid crystal display panel and a light source which selectively produces red, blue, and green, in the presence of external light. According to the field sequential color method, image according to each produced color is sequentially displayed on the liquid crystal panel to start drive. Thus, the liquid crystal panel has to have a sufficiently high response speed.

According to the field sequential color method, for example, one color has to be displayed in a period which is ⅓ of one field. For this reason, for example, when display at 60 fields/second is performed, the time available for display is about 5 ms (milliseconds). Thus, liquid crystal itself is required to have a response time shorter than 5 ms. As liquid crystal for achieving high-speed response, ferroelectric liquid crystal, antiferroelectric liquid crystal, narrow-gap nematic liquid crystal, OCB-mode liquid crystal, and the like are known.

However, in a display element which uses such liquid crystal, a polarizing plate is used. For this reason, transmittance is degraded, and when a viewer looks the rear side through the display element, visibility is degraded. Accordingly, in the image display according to the invention, as described below, a liquid crystal display element is used which can be in a light transmitting state and a light scattering state, and can reduce a response time required for switching from the light transmitting state to the light scattering state at normal temperature (for example, 25° C.) and a response time required for switching from the light scattering state to the light transmitting state at normal temperature shorter than 5 ms. Although the response speed of liquid crystal generally decreases at low temperature, it is possible to cope with a temperature range appropriate to the purpose through temperature compensation.

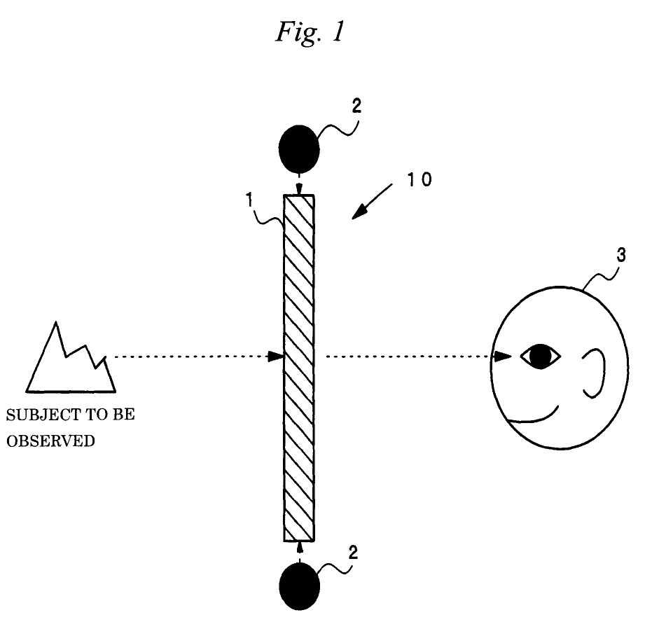

FIG. 1 is a schematic exterior view showing an example of the image display according to the invention. As shown in FIG. 1, an image display 10 includes a light source 2, such as an LED, in which time-division control is possible. A battery (electric cell) (not shown) supplies a drive voltage for a display element (electro-optical element) 1 and a turn-on voltage for the light source 2. The display element 1 can switch a liquid crystal layer between a transparence state and a light scattering state in accordance with presence/absence of voltage application to transparent electrodes based on a signal or the like from the outside, such that characters or figures can be displayed in accordance with the shapes or the like of the transparent electrodes.

If light is input from the light source 2 to the liquid crystal layer of the display element 1, a scattering portion of the liquid crystal layer scatters light and is recognized as bright by an observer 3. If the color of light of the light source 2 is changed to an arbitrary color, characters or figures can be displayed with the arbitrary color. The light source 2 is provided at the edge of the display element 1 to input light to the liquid crystal layer. A light guide portion is preferably provided between the light source 2 and the display element 1 to diffuse light. In the invention, the term “transparent” means a state where transmittance of light is equal to or greater than 50%, and preferably, equal to or greater than 80%. In the case of the transparence state, the observer 3 can look a subject to be observed through the display element 1. That is, the image display 10 has a function for transmitting light from the subject to be observed (light transmitting function).

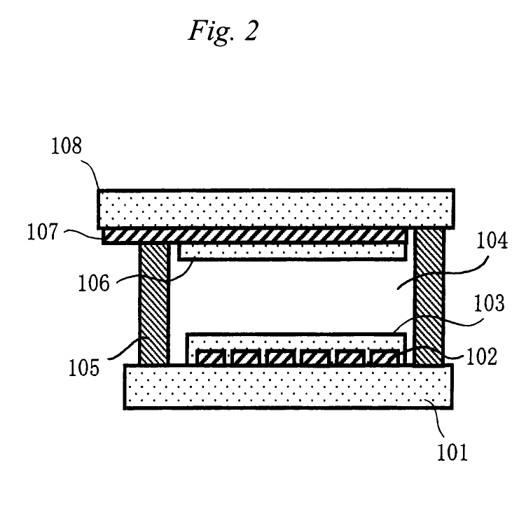

FIG. 2 is a schematic sectional view showing a configuration example of the display element 1 in the image display 10. In FIG. 2, transparent electrodes 102 and 107 are respectively provided on the opposing surfaces of a pair of substrates 101 and 108. Alignment films 103 and 106 are provided inside the transparent electrodes 102 and 107. A liquid crystal layer 104 is sandwiched between the alignment films 103 and 106. The liquid crystal layer 104 contains liquid crystal and the thickness thereof is controlled by spacers (not shown). The liquid crystal layer 104 is sealed by a seal layer 105.

The materials for the substrates 101 and 108 are not particularly limited insofar as transparency can be secured. As the substrates 101 and 108, glass substrates or plastic substrates may be used. The display element 1 does not have to have a planar shape, and may be curved.

For the transparent electrodes 102 and 107 formed on the substrates 101 and 108, transparent electrode materials including metal oxides, such as ITO (indium oxide-tin oxide), may be used. Hereinafter, the substrates 101 and 108 with the transparent electrodes 102 and 107 are referred to as electrode-attached substrates.

The liquid crystal layer 104 which can be in the light transmitting state and the light scattering state is preferably a liquid crystal layer which is formed as a liquid crystal/polymer complex by sandwiching a composition (hereinafter, referred to as an uncured composition) containing liquid crystal and a curable compound which is soluble in liquid crystal, between a pair of transparent substrates with electrodes, and curing the curable compound by using heat, ultraviolet rays, electronic beams, or the like. Hereinafter, liquid crystal which is made of a complex of liquid crystal and a polymer is also called a liquid crystal/polymer complex.

Liquid crystal for use in the liquid crystal/polymer complex may have positive or negative dielectric anisotropy. Meanwhile, in order to reduce the response time required for switching between the light transmitting state and the light scattering state, liquid crystal having low viscosity and negative dielectric anisotropy is preferably used. As liquid crystal, a compound which is not curable is used. The curable compound may have liquid crystallinity.

When liquid crystal having negative dielectric anisotropy is used, if processing is carried out for the electrode-attached substrates such that the pretilt angle of liquid crystal molecules in contact with the liquid crystal layer 104 is equal to or greater than 60 degrees with respect to the substrate surface, preferably, alignment defects can be reduced, and transparency can be improved. In this case, rubbing treatment may not be carried out. The pretilt angle is preferably equal to or greater than 70 degrees. With regard to the pretilt angle, the direction perpendicular to the substrate surface is defined as 90 degrees.

Liquid crystal which constitutes the liquid crystal/polymer complex for forming the liquid crystal layer 104 may be appropriately selected from known liquid crystal. By using the electrode-attached substrates in which the pretilt angle of the uncured composition can be controlled by the alignment films 103 and 106, liquid crystal having positive dielectric anisotropy or liquid crystal having negative dielectric anisotropy may be used. Meanwhile, from the viewpoint of higher transparency or response speed, liquid crystal having negative dielectric anisotropy is preferably used. The alignment films may be subjected to rubbing treatment. Further, in order to reduce the drive voltage, the absolute value of dielectric anisotropy preferably is preferably large.

The curable compound which constitutes the liquid crystal/polymer complex preferably has transparency. Further, if liquid crystal and the curable compound are separated from each other such that only liquid crystal responds when a voltage is applied after being cured, preferably, the drive voltage can be decreased.

According to the invention, of curable compounds which are soluble in liquid crystal, a curable compound is used which can control the alignment state of a mixture of liquid crystal and a curable compound when being uncured, and can maintain high transparency when being cured.

As the curable compound, a compound represented by Expression (1) or a compound represented by Expression (2) may be exemplified.

A¹-O—(R¹)ₘ—O—Z—O—(R²)ₙO-A (1)

A³-(OR³)ₒ—O—Z′—O—(R⁴O)ₚ-A⁴ (2)

Here, A¹, A², A³, and A⁴ represent an acryloyl group, a methacryloyl group, a glycidyl group, or an allyl group as a curing region independently; R¹, R², R³, and R⁴ represent an alkylene group having a carbon number of 2 to 6 independently; Z and Z′ represent a divalent mesogenic structure portion independently; m, n, o, and p represent an integer of 1 to 10 independently. The term “independently” means that a combination is arbitrary and any combination is available.

In Expressions (1) and (2), an oxyalkylene structure having high molecular mobility which contains R¹, R², R³, and R⁴ is introduced between the mesogenic structures Z and Z′ and the cured regions A¹, A², A³, and A⁴, such that molecular mobility of the curing regions can be improved in the course of curing and curing can be sufficiently carried out in a short time.

In Expressions (1) and (2), for the curing regions A¹, A², A³, and A⁴, any of the above-described photo-curable or thermosetting functional groups may be used. Of these, an acryloyl group or a methacryloyl which is appropriate to photo-curing is preferably used since the temperature at the time of curing can be controlled.

In Expressions (1) and (2), the carbon number of each of R¹, R², R³ and R⁴ is preferably 1 to 6 from the viewpoint of molecular mobility. An ethylene group having a carbon number of 2 and a propylene group having a carbon number of 3 are more preferably used.

In Expressions (1) and (2), as the mesogenic structure portions Z and Z′, a linked polyphenylene group of 1,4-phenylene group may be exemplified. A portion of the 1,4-phenylene group or the entire 1,4-phenylene group may be substituted with a 1,4-cyclohexylene group. A part or all of hydrogen atoms of the 1,4-phenylene group or the substituted 1,4-cyclohexylene group may be substituted with a substituent group having a carbon number of 1 to 2, such as an alkyl group, halogen atoms, a carboxyl group, or an alkoxycarbonyl group.

Preferred examples of the mesogenic structure portions Z and Z′ include a biphenylene group in which two 1,4-phenylene groups are linked (hereinafter, a biphenylene group in which two 1,4-phenylene groups are linked is also referred to as a 4,4-biphenylene group), a terphenylene group in which three 1,4-phenylene groups are linked, and biphenylene groups in which 1 to 4 hydrogen atoms are substituted with an alkyl group, fluorine atoms, chlorine atoms, or a carboxyl group having a carbon number of 1 to 2. The 4,4-biphenylene group having no substituent group is most preferably used. Bonds between 1,4-phenylene groups or 1,4-cyclohexylene groups constituting the mesogenic structure portion may be all single bonds or the following bonds.

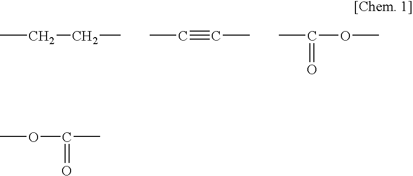

In Expressions (1) and (2), m, n, o, and p are preferably 1 to 10 independently, and more preferably, 1 to 4. This is because, if m, n, o, and p are very large, compatibility with liquid crystal is degraded, and transparency of the electro-optical element after curing is degraded.

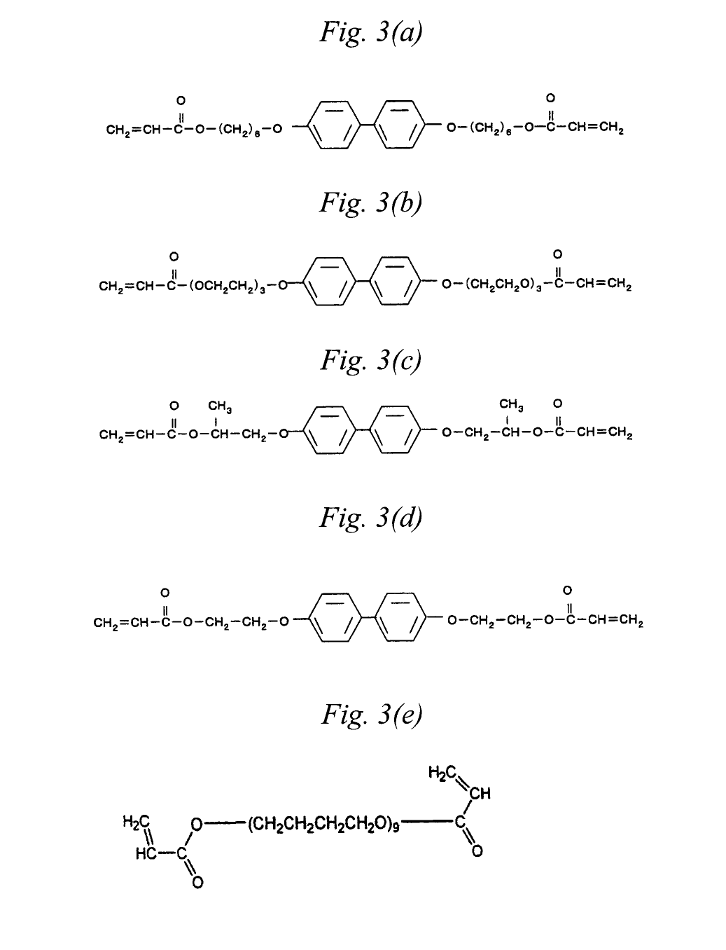

FIG. 3 shows an example of a curable compound which is available in the invention. A composition containing liquid crystal and a curable compound may contain the curable compound expressed by Expressions (1) and (2), or may contain a plurality of curable compounds. For example, if a composition contains a plurality of curable compounds in which m, n, o, and p in Expression (1) and (2) are different, compatibility with liquid crystal may be improved.

A composition containing liquid crystal and a curable compound may contain a curing catalyst. In the case of photo-curing, a photopolymerization initiator, such as benzoin ether series, acetophenone series, or phosphine oxide series, which is generally in photo-curable resin, may be used. In the case of thermosetting, a curing aid, such as peroxide series, thiol series, amine series, or acid anhydride, may be used in accordance with the type of the curing region. If necessary, a curing aid, such as amine series, may be used.

The content of the curing catalyst is preferably equal to or smaller than 20% by mass of the contained curable compound. When a high molecular weight or high specific resistance of cured resin after curing is required, the content of the curing catalyst is preferably 0.1 to 5% by mass.

In an uncured composition, the total amount of the curable compound is preferably 0.1 to 20% by mass with respect to the liquid crystal composition. If the total amount of the curable compound is smaller than 0.1% by mass, the liquid crystal phase cannot be divided into a domain structure having a shape more effective for a cured material, and a desired transmission-scattering characteristic cannot be obtained. Meanwhile, if the total amount of the curable compound exceeds 20% by mass, similarly to the known liquid crystal/cured material complex, the haze value in the transmitting state is likely to be increased. More preferably, the content of the cured material in the liquid crystal composition is 0.5 to 15% by mass, such that scattering intensity in the light scattering state can be increased, and a voltage value for transmission-scattering switching can be decreased.

As the processing method of aligning liquid crystal molecules such that the pretilt angle is equal to or greater than 60 degrees with respect to the substrate surface, a method is used in which a vertical alignment agent is used. As the method using a vertical alignment agent, for example, there is a method using a surfactant agent, a method in which the substrate interface is processed by a silane coupling agent containing an alkyl group or a fluoroalkyl group, or a method in which a commercially available vertical alignment agent, such as SE1211 manufactured by Nissan Chemical Industries, Ltd. or JALS-682-R³ manufactured by JSR, is used. In order to bring a state where liquid crystal molecules are tilted from the vertical alignment state to an arbitrary direction, any known method may be used. The vertical alignment agent may be subjected to rubbing. Further, a method may be used in which slits are provided in the transparent electrodes 101 and 107 or triangular columns are arranged on the electrodes 101 and 107, such that a voltage is applied obliquely with respect to the substrates 101 and 108. A device for tilting the liquid crystal molecules in a specific direction may not be provided.

The thickness of the liquid crystal layer 104 between the two substrates 101 and 108 can be defined by spacers or the like. The thickness of the liquid crystal layer 104 is preferably 1 to 50 and more preferably, 3 to 30 μm. If the thickness of the liquid crystal layer 104 is excessively small, contrast is degraded. If the thickness of the liquid crystal layer 104 is excessively large, undesirably, there are many cases where the drive voltage increasingly tends to be increased.

For the seal layer 105, any known resin may be used insofar as resin has high transparency. If resin having high transparency is used, transparency increases over the entire surface of the display element, and a state where characters or figures seem to be floated in the air is highlighted. For example, when glass substrates are used as the substrates 101 and 108, if epoxy resin or acrylic resin having a refractive index similar to the refractive index of glass is used, a state where transparent glass seems to be floated in the air can be realized. In the case of a use method in which a seal portion is not usually viewed by an observer, in particular, the seal layer has to be transparent.

In the image display 10 produced as described above, a very high response speed can be realized such that the response time between the light transmitting state and the light scattering state of a display image is shorter than 5 ms around at least normal temperature. Further, good viewing angle dependency is obtained, and an excellent light transmitting state can be obtained even when being viewed obliquely, as compared with a scattering/transmitting mode by the known dispersion liquid crystal element. For example, when a complex having the above-described configuration, which contains the curable compound and liquid crystal, is used, it is possible to eliminate a haze mostly even when being viewed obliquely at 40 degrees from the perpendicular state.

As the size of the display element 1, the length of the diagonal is about 1 cm to about 3 m. Any size of display element may be used.

In the image display 10, a plurality of display elements 1 may be used.

Further, in order to increase impact resistance of the display element 1, the upper and lower substrates 101 and 108 may be fixed.

Reflection prevention films or ultraviolet shielding films are preferably provided on the front and rear surfaces of the display element 1. For example, AR coat (low reflection coat) treatment using a dielectric multilayer film, such as SiO₂ or TiO₂, is performed on the front and rear surfaces of the display element 1, such that reflection of external light on the substrate surface can be reduced and contrast can be further improved.

As the light source 2, a light source, such as an LED, is used in which time-division control is possible. Meanwhile, in implementing the field sequential color method, for example, a method in which light sources of red, green, and blue are sequentially turned on, or a method in which a produced color is sequentially changed by combining color filters with respect to white light.

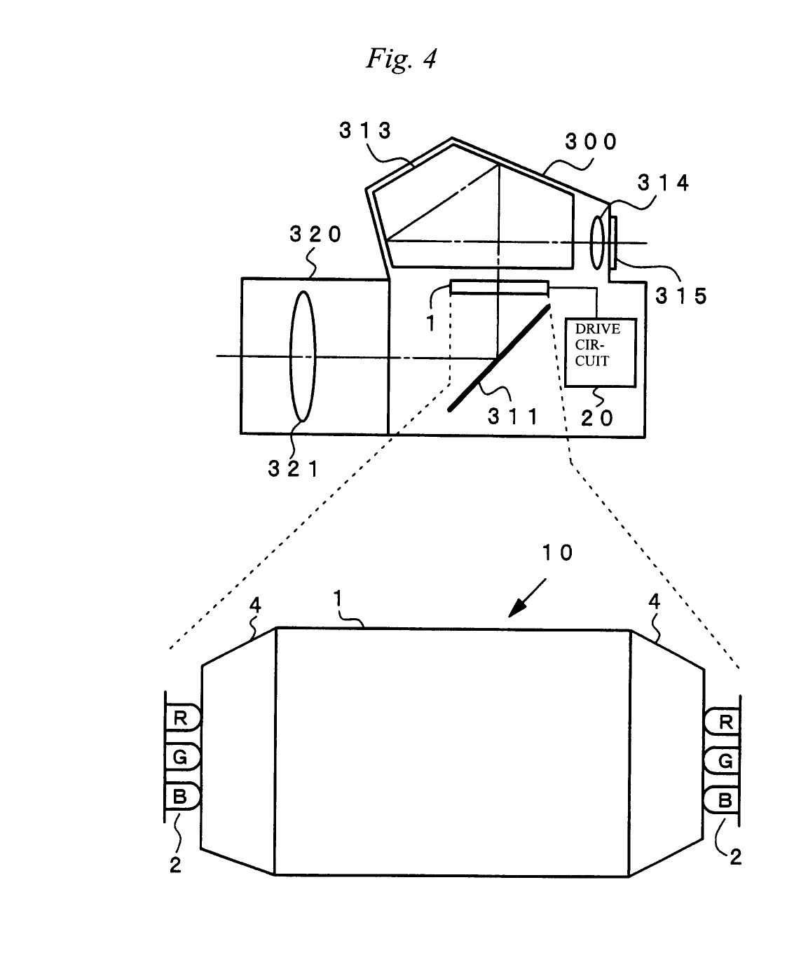

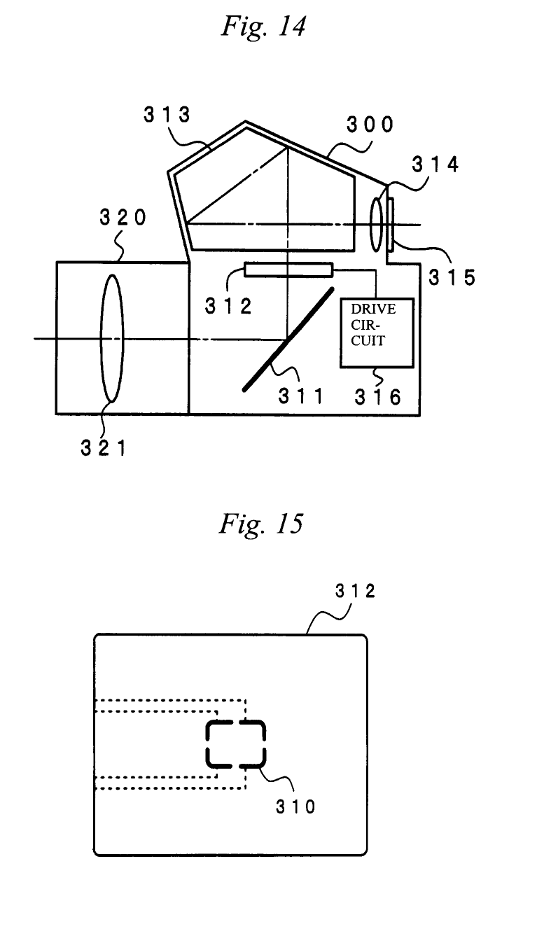

FIG. 4 is an explanatory view showing an application example of the image display 10 according to the invention. In the example of FIG. 4, the image display 10 (FIG. 4 shows only the display element 1 in the image display 10) is applied to a finder device for a camera. As shown in FIG. 4, the display element 1 is driven by a drive circuit 20, and other constituent elements are the same as the constituent elements shown in FIG. 14. Meanwhile, unlike the example of FIG. 14, if a voltage is applied between the substrates in the image display 10, the liquid crystal layer is brought into the light scattering state, and if no voltage is applied, the liquid crystal layer is brought into the light transmitting state. Thus, in a state where no voltage is applied, the user of the camera can view the subject to be observed through a see-through window 315. When a part of the liquid crystal layer is brought into the light scattering state, external light which is input from the lens 321 to the display portion in the light scattering state, is reflected by a prism 313, and light having passed the display portion in the light scattering state is not input to the eye lens 314 partially or entirely. Thus, the observer views the display portion in the light scattering state dark, that is, just about black.

As shown in the enlarged view of the image display 10 of FIG. 4, light guide portions (light guide plates) 4 are provided at the left and right edges of the display element 1 to have the substantially same thickness of the display element 1. Then, light from the light source 2 is input to the liquid crystal layer of the display element 1 through the light guide portions 4. The light guide portions 4 are formed by, for example, acrylic plates. Light input to the liquid crystal layer is substantially parallel to the surface liquid crystal layer (the surface parallel to the substrate surface), such that leakage of the light input when the light liquid crystal layer is in the light transmitting state, from the display surface of the display element 1, is reduced. If input light is further completely parallel to the surface of the liquid crystal layer, light leakage is further reduced.

In the example of FIG. 4, as the light source 2, LED light sources which respectively emit light of red (R), green (G), and blue (B) are used. The light source 2 inputs a light source color to the liquid crystal layer substantially in parallel to the surface of the liquid crystal layer from the lateral parts of the display element 1 through the light guide portions 4. Although light emission of an LED has rectilinearity, when the light guide portions 4 are provided, if light is input to the light guide portions 4, surface reflection is repeated within the light guide portions 4, such that light spreads in a wide range and is then input to the liquid crystal layer.

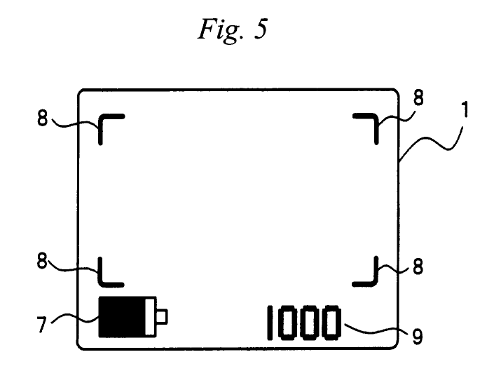

FIG. 5 is an explanatory view showing a display example of the display element 1. In the example of FIG. 5, a mark 7 indicating a remaining battery level, a mark 8 indicating a photographable range, and a mark 9 indicating a shutter speed are displayed on the display element 1. In the example of FIG. 5, the shutter speed is 1/1000 second. An area other than the areas where the marks 7, 8, and 9 are displayed, in particular, an area surrounded by the mark 8 indicating the photographable range is a transparent area.

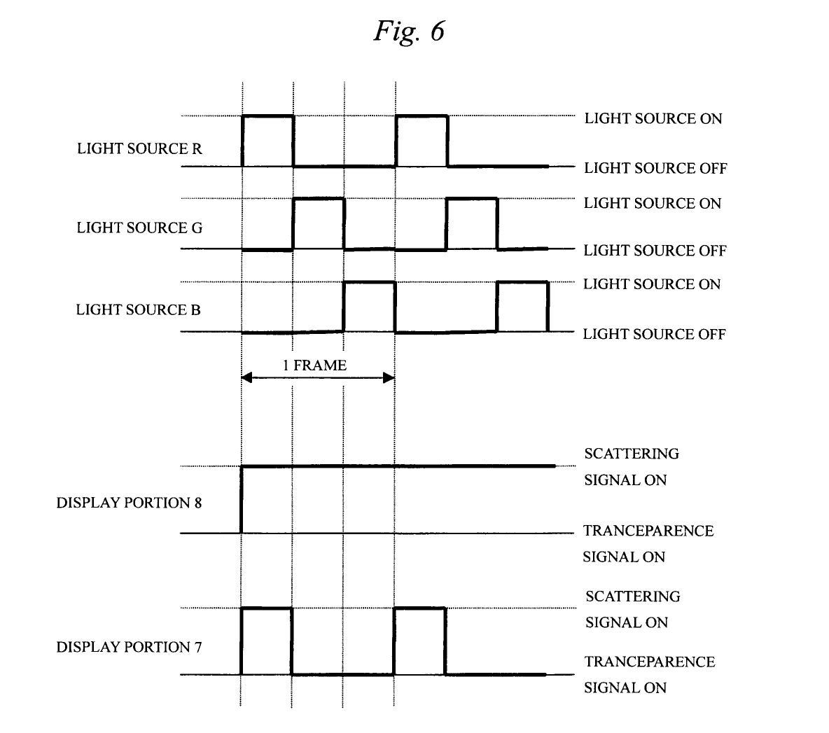

Next, the relationship between the light source 2 and drive of the display element 1 in the field sequential color method used in the image display 10 of the invention will be described with reference to a timing diagram of FIG. 6.

It is assumed that, in the display element 1 of FIG. 5, white is produced in the area of the mark 8, or red is produced in the area of the mark 7 such that black is viewed through observation beyond the eye lens 314 in a state where the light source is not turned-on. As the light source 2, light sources of three colors of red, green, and blue are used. As shown in FIG. 6, three colors are sequentially turned on, and a cycle in which all of RGB are turned on once is defined as one frame. With regard to an R turn-on period, a G turn-on period, and a B turn-on period, if the area of the mark 8 is in the light scattering state, white is produced in the area of the mark 8. Further, with regard to a period in which the light source 2 is not turned on, if the area of the mark 8 is in the light scattering state, the area of the mark 8 is viewed just about black through observation beyond the eye lens 314 since external light scatters. The area of the mark 7 is in the light scattering state only during the R turn-on period, and if the area of the mark 7 is in the light transmitting state during the G and B turn-on periods, the area of the mark 7 produces red. Thus, when display of light source color or black is performed in at least a portion of the display element 1, a portion where display is not performed may be controlled in the light scattering state or the light transmitting state in conjunction with the turn-on state of the light source in the presence of external light.

The cycle of one frame corresponding to the turn-on periods of the light sources of three colors is preferably equal to or smaller than (1/15) seconds. That is, the frame frequency corresponding to the frequency of turn-on of each of the light sources of three colors is equal to or greater than 15 Hz. This is because, if the frame frequency is smaller than 15 Hz, flickering is likely to be viewed. The frame frequency is more preferably equal to or greater than 30 Hz, and still more preferably, equal to or greater than 60 Hz.

The display element 1 produced as described above is brought into the light scattering state when a predetermined voltage (for example, 60 V) is applied to the liquid crystal layer 104, which can be in the light transmitting state and the light scattering state, and is brought into the light transmitting state when no voltage is applied to the liquid crystal layer 104. Thus, in FIG. 6, the term “scattering signal ON” corresponds to a state where a predetermined voltage is applied between the transparent electrodes 102 and 107, and the term “transparence signal ON” corresponds to a state where a potential difference between the transparent electrodes 102 and 107 is 0 V.

Hereinafter, signals for generating timing of light source ON and light source OFF shown in FIG. 6, that is, signals for instructing the rising edge and falling edge of light source ON and light source OFF to the respective light sources are called switching signals.

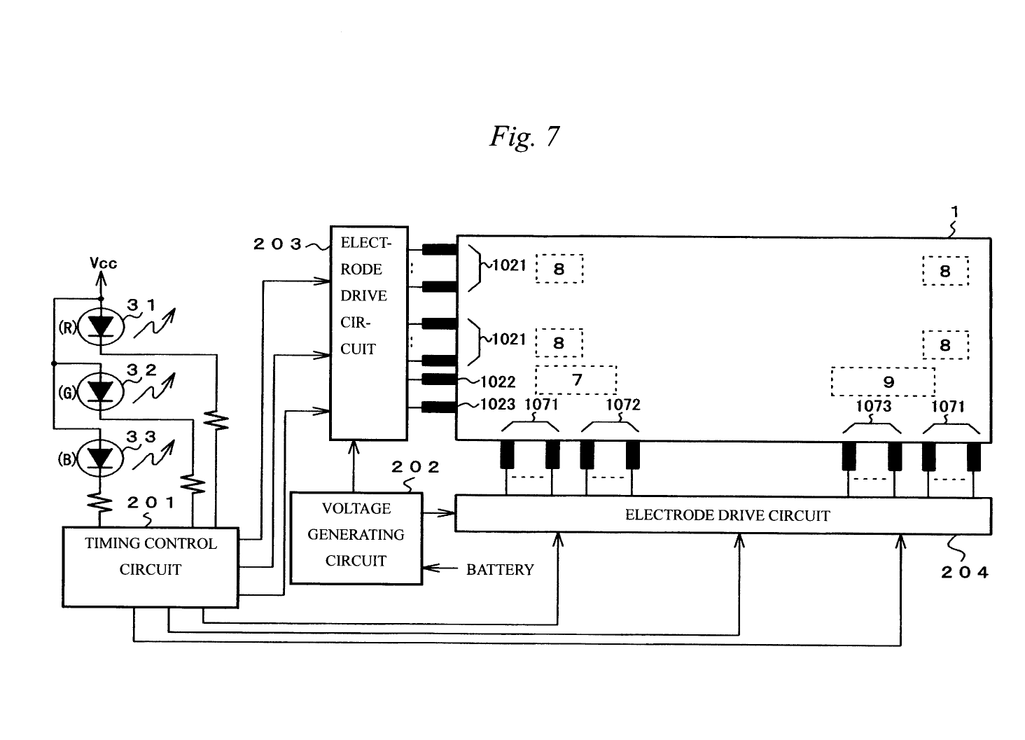

FIG. 7 is a block diagram showing a configuration example of a drive circuit for driving the display element 1. The drive circuit shown in FIG. 7 corresponds to the drive circuit 20 shown in FIG. 4. In the example of FIG. 7, an electrode drive circuit 203 and an electrode drive circuit 204 are provided. The electrode drive circuit 203 applies a drive voltage to one transparent electrode 1021 for driving the area of the mark 8 (hereinafter, also referred to as a display portion 8), one transparent electrode 1022 for driving the area of the mark 7 (hereinafter, also referred to as a display portion 7), and one transparent electrode 1023 for driving the area of the mark 9 (hereinafter, also referred to as a display portion 9) in accordance with an instruction of a timing control circuit 201. The electrode drive circuit 204 applies a drive voltage to the other transparent electrode 1071 for driving the area of the display portion 8, the other transparent electrode 1072 for driving the area of the display portion 7, and the other transparent electrode 1073 for driving the area of the display portion 9 in accordance with an instruction of the timing control circuit 201. A voltage generating circuit 202 supplies a drive voltage to the electrode drive circuit 203 and the electrode drive circuit 204. The voltage generating circuit 202 receives power supply, for example, from a battery mounted in a camera.

The transparent electrodes 1021, 1022, and 1023 correspond to the transparent electrodes 102 shown in FIG. 2, and the transparent electrodes 1071, 1072, and 1073 correspond to the transparent electrodes 107 shown in FIG. 2. In FIG. 7, only lead portions of the transparent electrodes 1021, 1022, 1023, 1071, 1072, and 1073 are shown.

Although in FIG. 7, the areas of the display portions 7, 8, and 9 are shown as the areas surrounded by dotted lines, actually, transparent electrodes made of ITO or the like are provided in the portions where display is performed as illustrated in FIG. 5, and extend from the transparent electrodes 1021, 1022, and 1023 and the transparent electrodes 1071, 1072, and 1073 shown in FIG. 7. That is, an equivalent to a wiring pattern from the portions of the transparent electrodes 1021, 1022, and 1023 and the portions of the transparent electrodes 1071, 1072, and 1073 shown in FIG. 7 to the portion illustrated in FIG. 5 where no display is performed is formed on the front and rear surfaces of the display element 1.

The timing control circuit 201 turns on a red light source (red LED) 31, a green light source (green LED) 32, and a blue light source (blue LED) 33 in the light source 2 with timing illustrated in FIG. 6. That is, switching signals are provided to the red light source 31, the green light source 32, and the blue light source 33. The display portion 8 is formed by a plurality of segments. In a state of scattering signal ON, an instruction is provided to the electrode drive circuit 203 such that a drive voltage (for example, −30 V) is applied to the transparent electrodes 1021 corresponding to a common electrode, and an instruction is provided to the electrode drive circuit 204 such that a drive voltage (for example, +30 V) is applied to the transparent electrodes 1071 connected to segments to be displayed in accordance with display data.

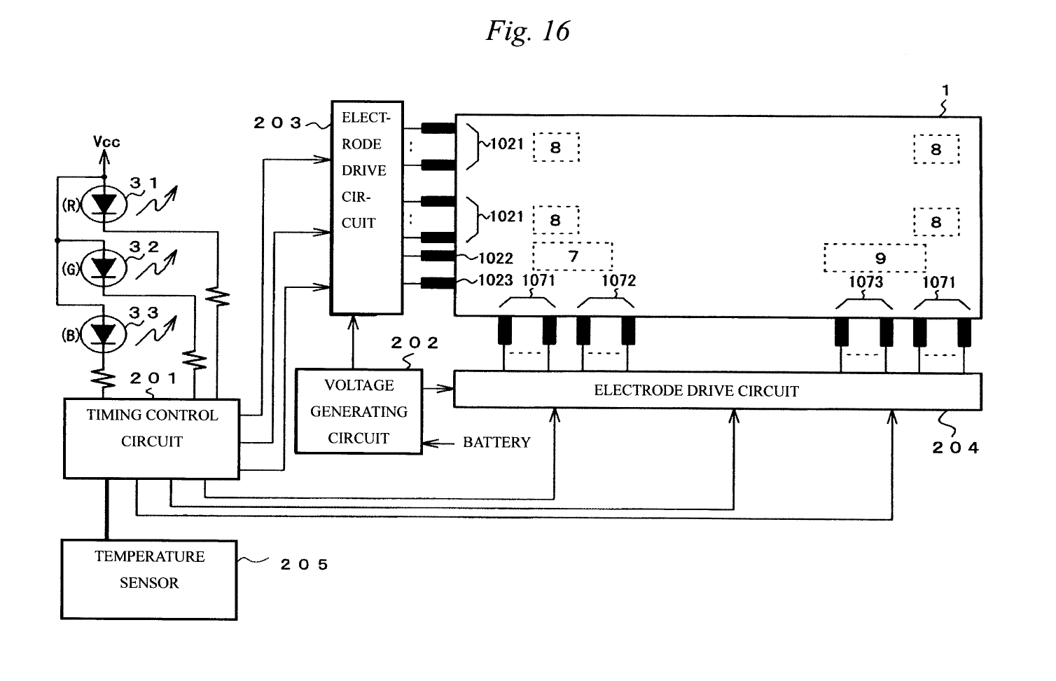

FIG. 16 is a block diagram showing another configuration example of the drive circuit for driving the display element 1. In this example, temperature compensation is carried out by a temperature sensor 205 attached to the timing control circuit, in particular, at low temperature. For example, timing modulation of light source ON and OFF is carried out on the basis of parameters at each temperature.

Although the drive voltage which is applied to the transparent electrodes 1021 and the transparent electrodes 1071 is, for example, ±30 V, alternating-current drive is preferably carried out while changing positive and negative of the drive voltage of the transparent electrodes 1021 and the drive voltage of the transparent electrodes 1071 with predetermined timing. However, since high frequency is one of causes for an increase in power consumption, the drive voltage is preferably set in consideration of appropriate balance.

The display portions 7 and 9 are formed by a plurality of segments. In a state of scattering signal ON shown in FIG. 6, the timing control circuit 201 provides an instruction to the electrode drive circuit 203 such that the drive voltage (for example, −30 V) is applied to the transparent electrodes 1022 and 1023 corresponding to a common electrode, and provides an instruction to the electrode drive circuit 204 such that the drive voltage (for example, +30 V) is applied to the transparent electrodes 1072 and 1073 connected to the segments to be displayed.

In the display element 1, when a TFT element is used as a drive element, if the scattering signal is in the OFF state and the display element 1 is in the transparence state, the viewer is likely to view the TFT element. However, in this embodiment, the display element 1 does not include an active element, such as a TFT element, and is driven statically, thus there is no case where an object which does not have to be viewed originally is viewed in the transparence state.

Although production of RGB can be switched substantially simultaneously with input of the switching signal, the display portions 7, 8, and 9 cannot be changed immediately with respect to input of the scattering signal or transparence signal (specifically, start of application of the drive voltage to the transparent electrodes 1021, 1022, 1023, 1071, 1072, and 1073 or erasure of the drive voltage). This is because responsiveness of the display element has a delay. If the light scattering state is maintained other than a desired light source color, color mixture occurs, causing color deterioration. For this reason, it is necessary to prevent occurrence of a situation where the light scattering state is maintained other than a desired light source color. Therefore, the timing of switching signal input to the light source and the timing of signal input (start of application of the drive voltage or erasure of the drive voltage) to the display portions 7, 8, and 9 are preferably deviated from each other.

For example, as shown in FIG. 8, the timing control circuit 201 performs timing control such that the start time of transparence signal ON for the display portion 7 is advanced with respect to the switching signal, or an OFF period in which scattering signal ON is not set for the display portion 8 is provided immediately before the switching signal, reducing color deterioration. FIG. 8 also shows an example where the display portion 8 produces white and the display portion 7 produces red.

If the OFF period shown in FIG. 8 is extended, the period of scattering signal ON is shortened, and the display portion is darkened. The OFF period is preferably about 2 ms such that the period of scattering signal ON is extended as long as possible while preventing color mixture occurring when the light scattering state is maintained other than a desired light source color.

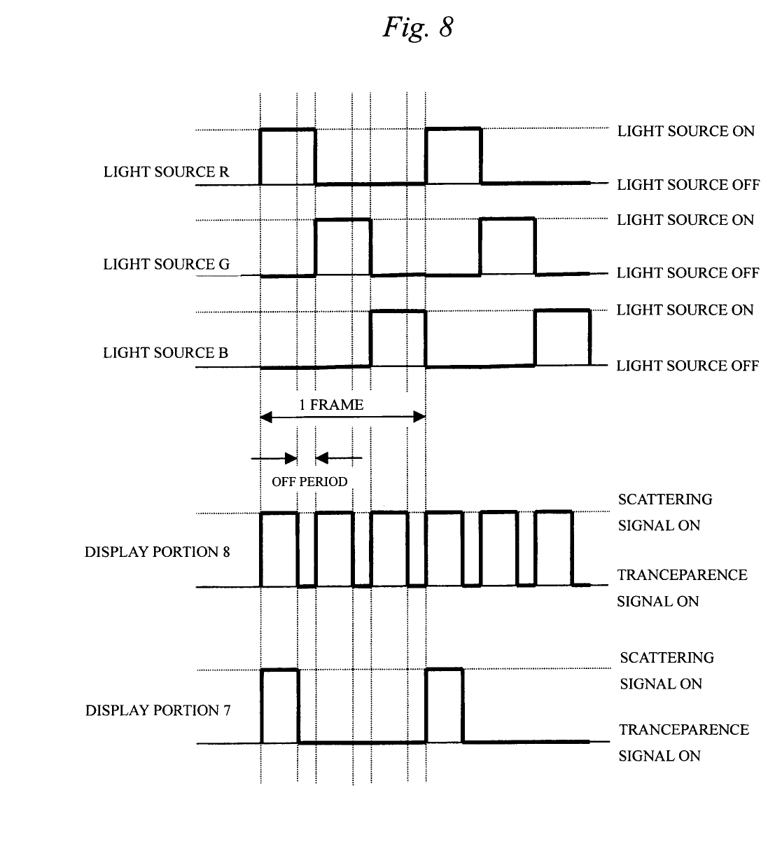

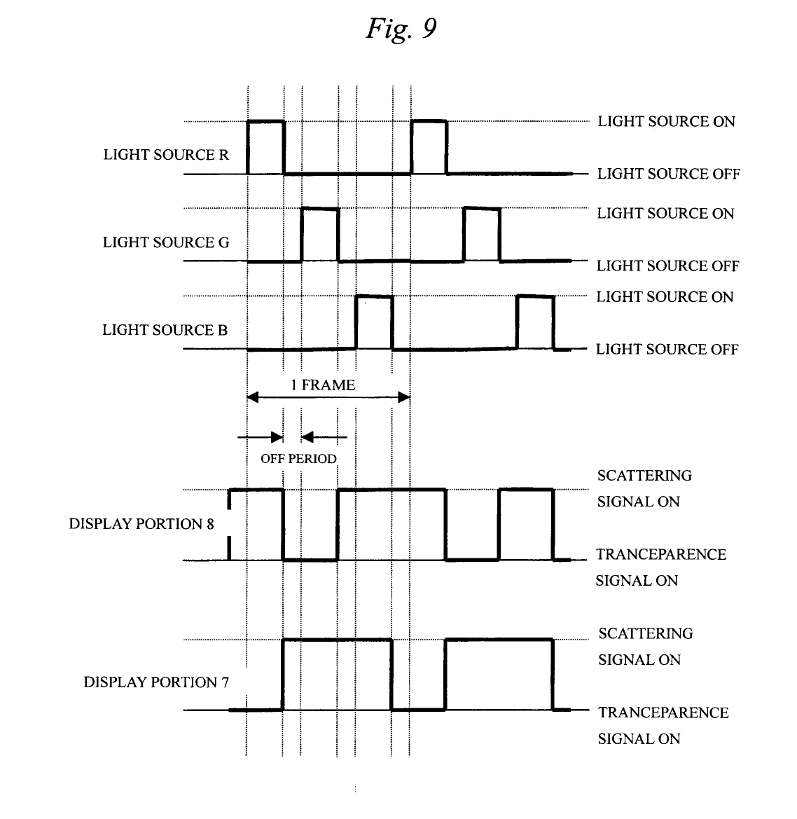

As shown in FIG. 9, the timing control circuit 201 also performs timing control such that the OFF time is provided between the ON time of each of the light sources 31, 32, and 33 and the next ON time, reducing color deterioration. In the example of FIG. 9, unlike the example of FIG. 8, the period of scattering signal ON is not shortened. Further, in the example of FIG. 9, the display portion 8 is viewed as RB mixed color is produced, and the display portion 7 is viewed as GB mixed color is produced.

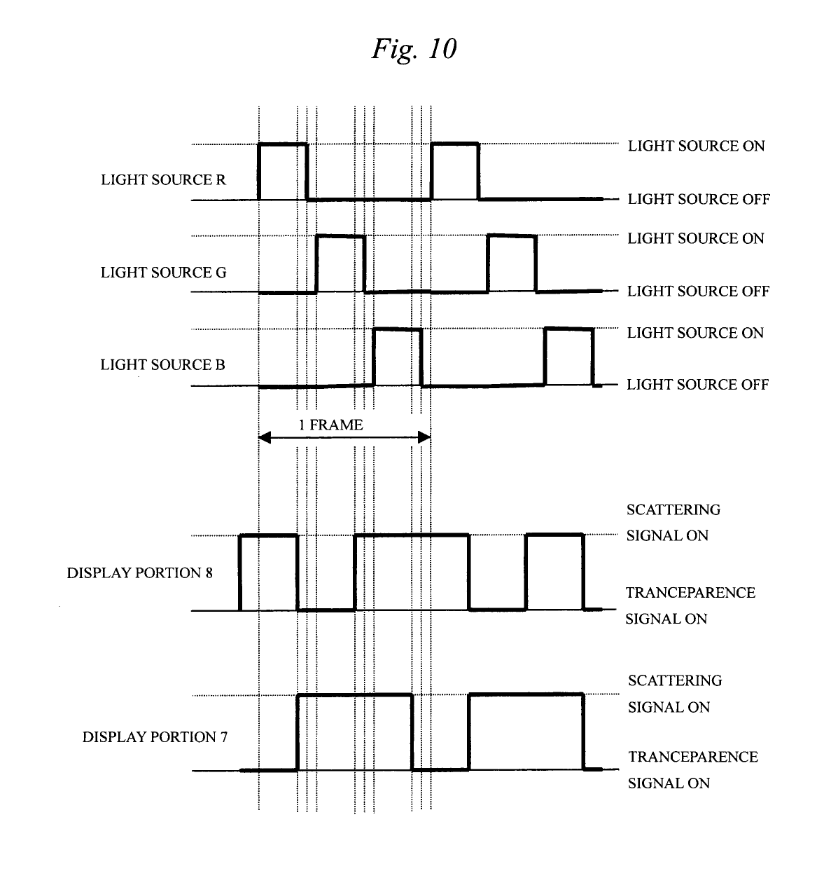

As shown in FIG. 10, the timing control circuit 201 also performs timing control such that the OFF time is provided between the ON time of each of the light sources 31, 32, and 33 and the next ON time, and scattering signal ON and transparence signal ON start before the light sources 31, 32, and 33 are turned off, reducing color deterioration. In the example of FIG. 10, the display portion 8 is viewed as RB mixed color is produced, and the display portion 7 is viewed as GB mixed color is produced.

The use of the field sequential color method makes it possible to simultaneously obtain desired produced colors in the respective areas of the display element 1. For example, the mark 8 (see FIG. 5) can be displayed green, the mark 7 (see FIG. 5) can be displayed red, and the mark 9 (see FIG. 5) can be displayed blue. The colors can be changed in accordance with the display contents, and the color change enables the user to easily grasp information. Further, a subject to be observed in the background can be viewed from the transparent portion with no problem.

When the three light sources 31, 32, and 33 are provided, and the display portions are brought into the light scattering state, the display portions of the display element 1 can produce seven colors of red, RG mixed color, RB mixed color, RGB mixed color (white), green, GB mixed color, and blue. That is, if transparence when the light sources are not turned on and the display portions are in the light transmitting state is included, eight colors can be produced. Further, if black due to external light when the light sources are not turned on and the display portions in the light scattering state is include, nine colors can be produced. If the mixed color is called multi-color, single-color display and multi-color display can be simultaneously performed in different display portions of the single display element 1.

Display in which the display color is a single color and display in which the display color is multi-color may be performed with different timing in the single display portion. For example, the display portion 7 may produce red in one period and may produce RB mixed color in another period. If display in which the display color is a single color and display in which the display color is multi-color are carried out with different timing, for example, the mark 7 indicating the remaining battery level may be displayed with different colors in accordance with the remaining battery level, or the mark indicating the focus area may be displayed green to indicate in-focus and may be displayed red to indicate out-of-focus.

Although in the examples of FIGS. 6 and 8 to 10, the length of the period of scattering signal ON is basically a single type, the timing control circuit 201 may variably control the length of the period of scattering signal ON, such that many types of colors can be produced.

Although in this embodiment, a case has been described where the three light sources 31, 32, and 33 are provided as the light source 2, two light sources which produce different light source colors may be used. When two light sources are used, multiple display colors based on light source colors can be obtained in the display element 1 by the field sequential color method.

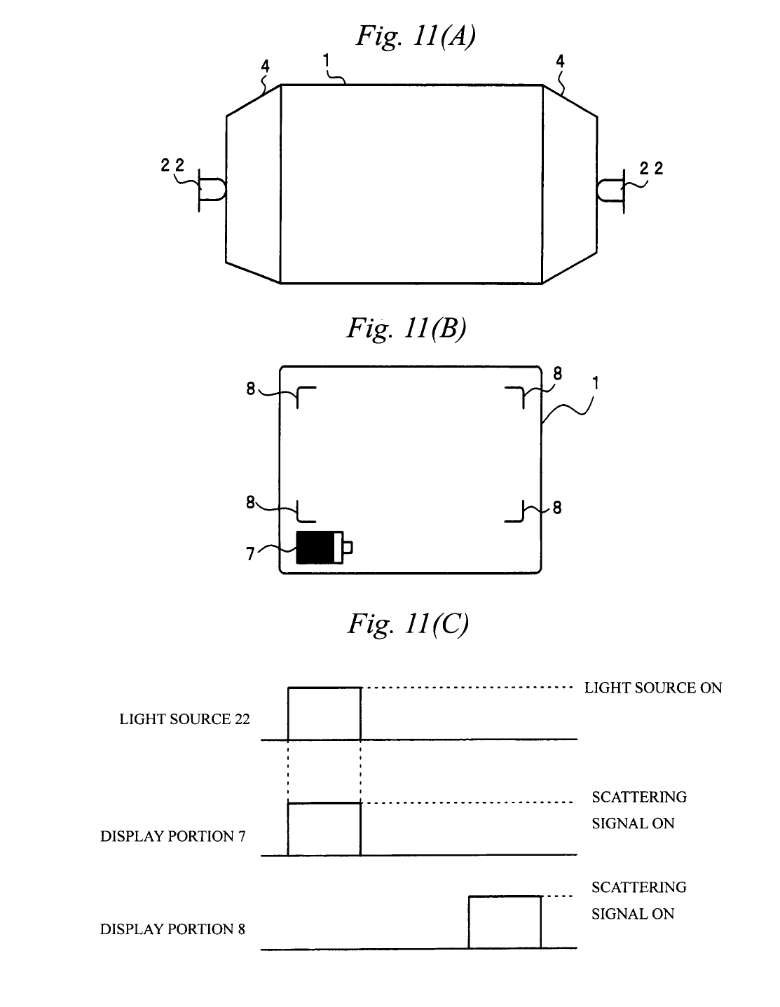

Although in the examples of FIGS. 4, 6, and 8 to 10, the three light sources 31, 32, and 33 are provided as the light source 2, as shown in FIG. 11(A), a single light source 22 which emits single-color light (in the example of FIG. 11(A), light sources are respectively provided on the left and right sides) may be provided as the light source 2.

As shown in FIG. 11(A), in the configuration where the single light source 22 is provided, as shown FIG. 11(B), when the marks 7 and 8 are displayed visibly, for example, the electrodes connected to the mark 7 are driven in synchronization with emission of light from the light source 22, such that the area of the mark 7 is brought into the light scattering state, and the mark 7 is produced with a light source color. As shown in FIG. 11(C), the electrodes connected to the mark 8 are driven to bring the area of the mark 8 into the light scattering state. At this time, the light source 22 is not controlled in the turn-on state, but the portion corresponding to the mark 8 is brought into the light scattering state. Thus, transmittance of light is decreased, and the viewer views the area of the mark 8 as a dark portion, that is, substantially original black, through observation beyond the eye lens 314 with respect to the area in the transparence state (the area other than the area of the mark 8). Even when the single light source 22 is used, in order to prevent flickering from being viewed, the frame frequency of the light source 22 is preferably equal to or greater than 15 Hz, and more preferably, equal to or greater than 30 Hz. Still more preferably, the frame frequency is equal to or greater than 60 Hz.

The ratio of the light emission period in one frame is preferably equal to or smaller than ⅓. If the light emission period exceeds ⅓, red display has no problem, but black display is light and scarcely viewed as black. Further, the ratio of the light emission period is more preferably equal to or smaller than ⅙. If the ratio of the light emission period is greater than ⅙, black display substantially has no problem, but there is a possibility that the irradiation time is lacking in accordance with irradiation intensity of the light source, red display is light and scarcely viewed as red.

When a mark indicating a focus area shown in FIG. 15 is displayed, a light source which produces red is used as the light source 22, and the scattering signal is in the ON state cyclically. Meanwhile, there may be a way to use in which the light source 22 is not turned on at the time of out-of-focus, and is turned on in synchronization with the scattering signal at the time of in-focus. In this case, at the time of out-of-focus, similarly to the area of the mark 8, the mark is viewed as a dark portion, and at the time of in-focus, the mark is viewed red. That is, visibility regarding in-focus or out-of-focus is further improved.

The image display 10 according to the invention may be widely applied to an optical microscope or binoculars, in addition to the finder device for the camera, for the purpose of superimposingly displaying information through the see-through for the observer when the observer 3 observes a subject to be observed through the see-through window or the like.

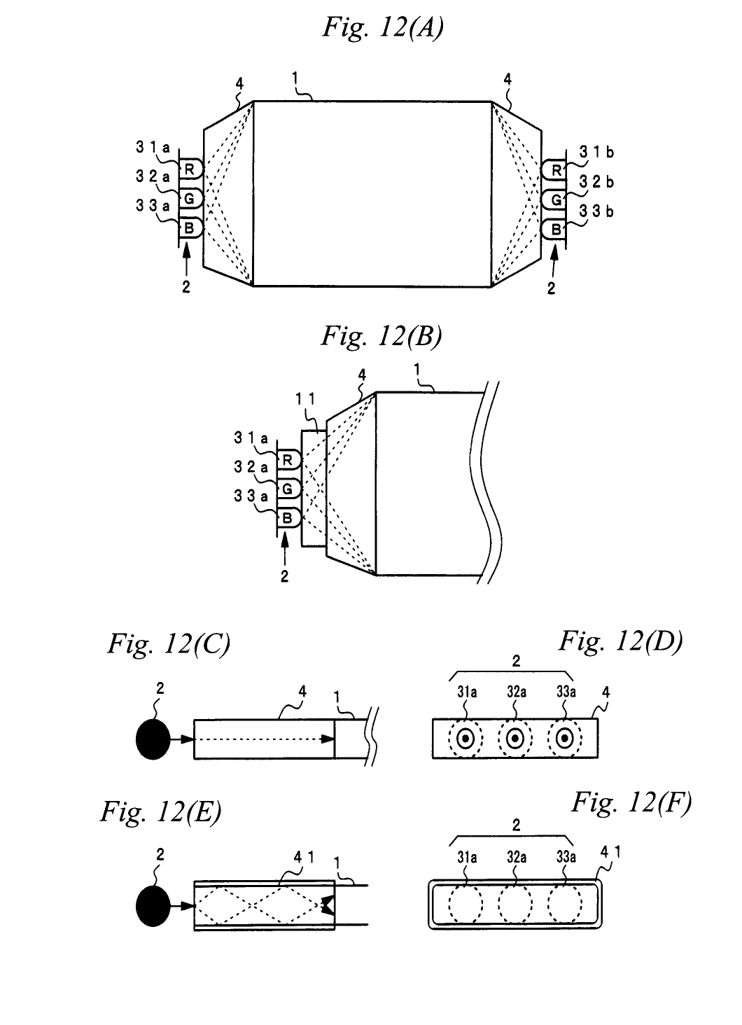

FIG. 12 is an explanatory view illustrating the effect of the light guide portions 4. Light emitted from the light source 2 spreads in a wide range (spreads from one end to the other end at the lateral part of the display element 1) while repeating surface reflection within the light guide portions 4, and is input to the liquid crystal layer of the display element 1. Preferably, as shown in FIG. 12(A), with regard to all of R light sources 31a and 31b, G light sources 32a and 32b, and B light sources 33a and 33b in the light source 2, when light is input from the light guide portion 4 to the lateral surface of the liquid crystal layer of the display element 1, light is input entirely from one end of the lateral surface of the liquid crystal layer to the other end (in FIG. 12(A), from the upper end to the lower end). Although in this embodiment, the light sources 2 are provided on both lateral surfaces of the display element 1, the light source 2 may be provided on one lateral surface.

As shown in FIG. 12(B), a lens 11 may be provided between the light source 2 and the light guide portion 4 to expand the irradiation range of light from the R light source 31a, the G light source 32a, and the B light source 33a. Although FIG. 12(B) shows only the light sources 31a, 32a, and 33a on the left side of FIG. 12(A), the same is applied to the light sources 31b, 32b, and 33b on the right side. Although in FIG. 12(B), an example has been described where a single lens is provided, lenses may be provided to correspond to the light source 31a, 32a, and 33a.

As shown in FIGS. 12(C) and (D), light emitted from the light source 2 is preferably input to the liquid crystal layer of the display element 1 without going outside the light guide portion 4 (in FIGS. 12(C) and (D), the upper part and the lower part). FIG. 12(D) is a diagram when the light guide portion 4 is viewed from the display element 1 side. In FIG. 12(D), a solid-line circle indicates the travel direction of light of the light sources 31a, 32a, and 33a. Although FIGS. 12(C) and (D) show only the light source 2 (the light sources 31a, 32a, and 33a) on the left side in FIG. 12(A), the same is applied to the light sources 31b, 32b, and 33b on the right side.

Although surface reflection is repeated within the light guide portion 4, when a reflecting element is attached to the front or rear surface of the light guide portion 4, it is considered that scattering occurs and light leaks outside the light guide portion 4 before light reaches the display element 1. Thus, as shown in FIGS. 12(E) and (F), an optical fiber 41 may be used as the light guide portion 4. That is, if glass or synthetic resin is used for a core (center) and a clad (peripheral part), and the core has a refractive index higher than the clad, light input from the light source 2 propagates only through the core of the optical fiber 41 by total reflection or refraction, and is input to the lateral surface of the liquid crystal layer of the display element 1 without leaking outside. FIG. 12(F) is a diagram showing a case the light guide portion 4 is viewed from the display element 1. Although FIGS. 12(E) and (F) show only the light source 2 (the light sources 31a, 32a, and 33a) on the left side of FIG. 12(A), the same is applied to the light sources 31b, 32b, and 33b on the right side. The thickness of the optical fiber 41 is thin substantially the same as the thickness of the liquid crystal layer of the display element 1. Thus, it can be said that light emitted from the optical fiber 41 is input to the display element 1 substantially in parallel to the surface of the display element 1.

### EXAMPLES

Hereinafter, examples of the invention will be described. In the examples, the term “parts” means parts by mass.

### Example 1

Eighty-five parts of nematic liquid crystal (Tc=98° C., Δ∈=−5.6, Δn=0.220) having negative dielectric anisotropy, 12.5 parts of a bifunctional curable compound shown in FIG. 3(a), 2.5 parts of a bifunctional curable compound shown in FIG. 3(e), and benzoin isopropyl ether as a photopolymerization initiator were mixed. 1 part of benzoin isopropyl ether was mixed when the total amount of the curable compound (the compound shown in FIG. 3(a) and the compound shown in FIG. 3(e)) was 100 parts. The mixed liquid was heated at 90° C. while being stirred so as to obtain a liquid crystal phase, the mixed liquid was homogenized as an isotropic phase, and then the temperature dropped down to 60° C. Thereafter, it was confirmed that the mixed layer become a liquid crystal phase.

A liquid crystal cell was produced as follows. A pair of substrates 101 and 108 on which vertical alignment polyimide thin films 103 and 106 were formed on the transparent electrodes 102 and 107 were bonded to each other by epoxy resin (peripheral seal) printed on the four sides at a width of about 1 mm through a small amount of dispersed resin beads (diameter 6 μm) such that the vertical alignment polyimide thin films 103 and 106 were arranged to be opposite each other. Thus, a liquid crystal cell was formed. Next, the mixed liquid was filled in the liquid crystal cell.

In a state where the liquid crystal cell was maintained at 33° C., ultraviolet rays were irradiated at 3 mW/cm² from above and at about 3 mW/cm² from below for 10 minutes by an HgXe lamp having a main wavelength of about 365 nm. Thus, a display element in which a liquid crystal layer made of a liquid crystal/polymer complex was formed between the substrates was obtained.

The display element obtained as described above was in a uniform transparence state in a state where no voltage was applied. If a 200 Hz, 60 V square-wave voltage was applied to display element, the display element was changed as being clouded. Transmittance was measured by a Schlieren optical system (the F value of the optical value was 11.5, and the converging angle was 5°) using a measurement light source having a half bandwidth of about 20 nm with a center wavelength of 530 nm. In a state where no voltage is applied, transmittance was 80%, and the value of contrast obtained by dividing the value by transmittance when 60 Vrms was applied was 16.

Three LED light sources of red (R), green (G), and blue (B) were used as the light source 2. The relationship shown in FIG. 8 was used as the relationship between the light source and the drive signal of the display element. The frame frequency was 60 Hz, and the OFF period was 2 msec.

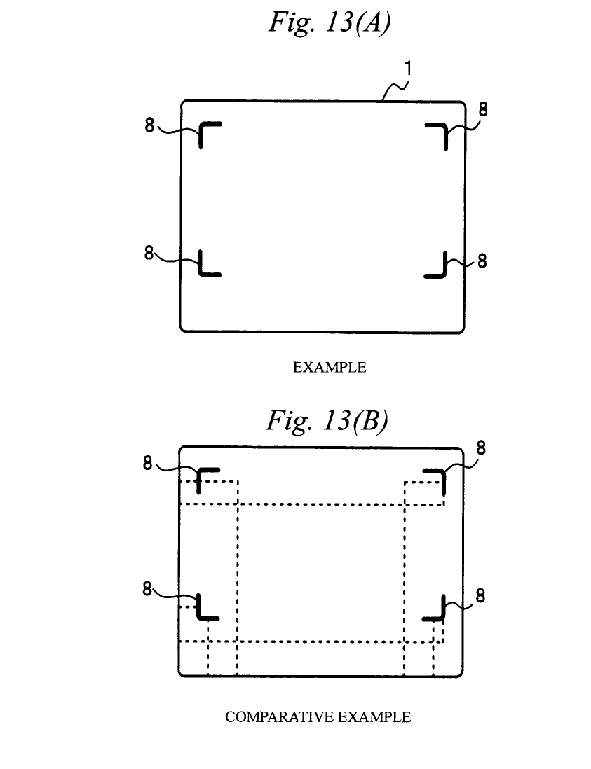

The display element 1 was placed as the display element of the image display 10 provided in the finder device for the camera shown in FIG. 4, and the mark 8 indicating a photographable range shown in FIG. 13 was displayed on the display element 1. As a result of viewing the image display 10, there was no case where the wiring pattern was viewed in an area other then the display portion.

At the lower end of FIG. 13, a comparative example is shown in which the mark 8 indicating a photographable range is displayed by the technique described in the “BACKGROUND ART”. In the comparative example, a wiring pattern indicated by a broken line was viewed.

### Example 2

Eighty-five parts of nematic liquid crystal (Tc=98° C., Δ∈=−5.6, Δn=0.220) having negative dielectric anisotropy, 12.5 parts of a bifunctional curable compound shown in FIG. 3(a), 2.5 parts of a bifunctional curable compound shown in FIG. 3(e), and benzoin isopropyl ether as a photopolymerization initiator were mixed. 1 part of benzoin isopropyl ether was mixed when the total amount of the curable compound (the compound shown in FIG. 3(a) and the compound shown in FIG. 3(e)) was 100 parts. The mixed liquid was heated at 90° C. while being stirred so as to obtain a liquid crystal phase, the mixed liquid was homogenized as an isotropic phase, and then the temperature dropped down to 60° C. Thereafter, it was confirmed that the mixed layer becomes a liquid crystal phase.

A liquid crystal cell was produced as follows. A pair of substrates 101 and 108 on which vertical alignment polyimide thin films 103 and 106 were formed on the transparent electrodes 102 and 107 were bonded to each other by epoxy resin (peripheral seal) printed on the four sides at a width of about 1 mm through a small amount of dispersed resin beads (diameter 6 μm) such that the vertical alignment polyimide thin films 103 and 106 are arranged to be opposite each other. Thus, a liquid crystal cell was formed. Next, the mixed liquid was filled in the liquid crystal cell.

In a state where the liquid crystal cell was maintained at 33° C., ultraviolet rays were irradiated at 10 mW/cm² from above and at about 10 mW/cm² from below for 10 minutes by an HgXe lamp having a main wavelength of about 365 nm. Thus, a display element in which a liquid crystal layer made of a liquid crystal/polymer complex was formed between the substrates was obtained.

The display element obtained as described above was in a uniform transparence state in a state where no voltage was applied. If a 200 Hz, 60 V square-wave voltage was applied to the display element, the display element was changed as being clouded. Transmittance was measured by a Schlieren optical system (the F value of the optical value was 11.5, and the converging angle was 5°) using a measurement light source having a half bandwidth of about 20 nm with a center wavelength of 530 nm. In a state where no voltage is applied, transmittance was 80%, and the value of contrast obtained by dividing the value by transmittance when 60 Vrms was applied was 18.

Three LED light sources of red (R), green (G), and blue (B) were used as the light source 2. The relationship shown in FIG. 8 was used as the relationship between the light source and the drive signal of the display element. The frame frequency was 60 Hz, and the OFF period was 2 msec.

The display element 1 was placed as the display element of the image display 10 provided in the finder device for the camera shown in FIG. 4, and the mark 8 indicating the photographable range shown in FIG. 13 was displayed on the display element 1. As a result of viewing the image display 10, there was no case where a wiring pattern was viewed in an area other than the display portion.

At the lower end of FIG. 13, a comparative example is shown in which the mark 8 indicating a photographable range is displayed by the technique described in the background art. In the comparative example, a wiring pattern indicated by a broken line was viewed.

### Example 3

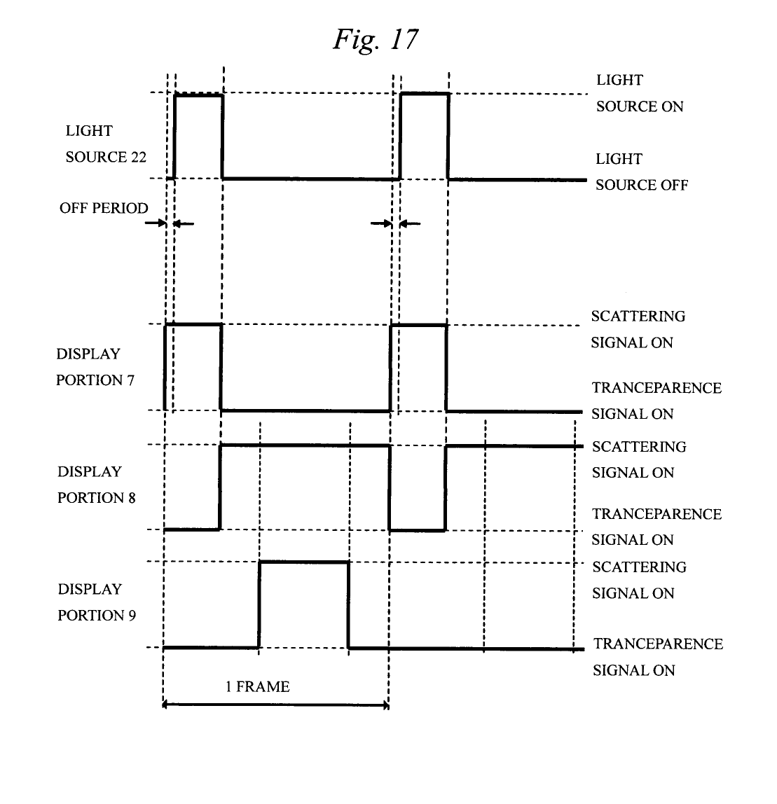

Similarly to Example 2, a display element in which a liquid crystal layer made of a liquid crystal/polymer complex was formed between the substrates was produced. A single LED light source of red (R) only was used as the light source 2. The relationship shown in FIG. 17 was used as the relationship between the light source and the drive signal of the display element. The display portions 7, 8, and 9 correspond to the mark 7 indicating the remaining battery level, the mark 8 indicating the photographable range, and the mark 9 indicating the shutter speed in FIG. 5. In this example, in a portion where red display is desired, that is, the display portion 7, light source ON is delayed later than the time of scattering signal ON, that is, the OFF time is provided in front of the light source turn-on period. The frame frequency was 60 Hz, and the OFF period was 1 ms.

The display element 1 was placed as the display element of the image display 10 provided in the finder device for the camera shown in FIG. 4, the mark 7 indicating the remaining battery level, the mark 8 indicating the photographable range shown in FIG. 5, and the mark 9 indicating the shutter speed were respectively on the display element 1. As a result of viewing the image display 10, the mark 7 was displayed red, the mark 8 was displayed black, and the mark 9 was displayed to be switched from black lighter than the mark 7, that is, gray, to transparence. Of course, there was no case where a wiring pattern was viewed in an area other than the display portions.

### Example 4

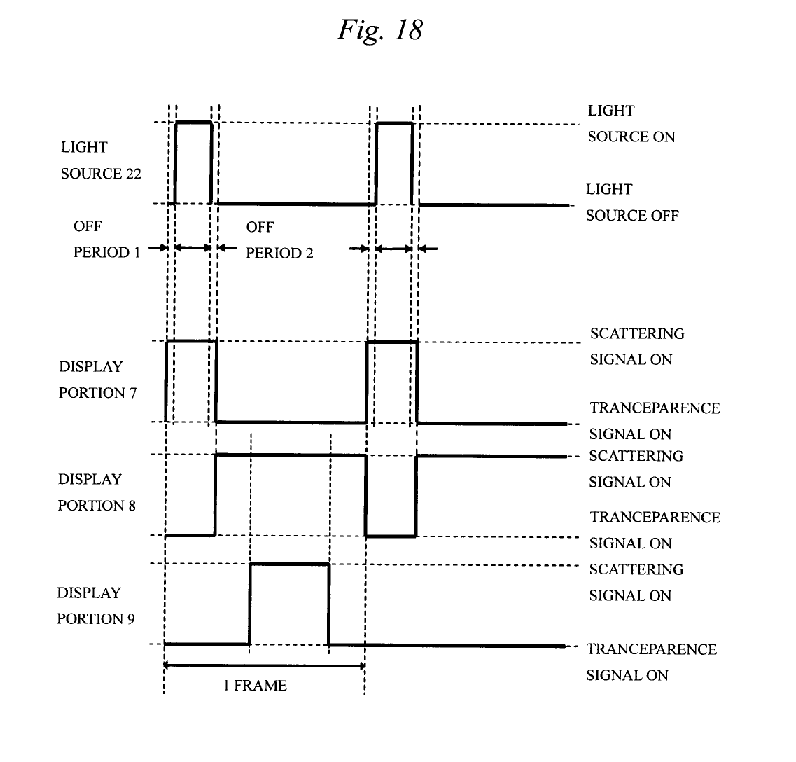

Similarly to Example 2, a display element in which a liquid crystal layer made of a liquid crystal/polymer complex was formed between the substrates was produced. A single LED light source of red (R) only was used as the light source 2. The relationship shown in FIG. 18 was used as the relationship between the light source and the drive signal of the display element. The display portions 7, 8, and 9 has the same meanings as in Example 3. In this example, in a portion where red display is desired, that is, the display portion 7, light source ON is delayed later than the time of scattering signal ON, and light source OFF is advanced earlier than the time of scattering signal OFF, that is, the OFF time is provided in front of and at the back of the light source turn-on period. The frame frequency was 60 Hz. When the LED turn-on period (the period of light source ON) was ⅓ of one frame, the OFF period 1 was 3 ms and the OFF period 2 was 1 ms. When the LED turn-on period was ⅙ of one frame, the OFF period 1 was 1 ms and the OFF period 2 was 0.5 ms. As described above, the OFF periods 1 and 2 can be appropriately adjusted in accordance with the balance between setting of the turn-on period of the LED in one frame, the response time of the liquid crystal optical element, and required appearance. As a control circuit, a control circuit having the configuration shown in FIG. 16, in which temperature control is possible, was used.

The display element 1 was placed as the display element of the image display 10 provided in the finder device for the camera shown in FIG. 4, and the mark 7 indicating the remaining battery level, the mark 8 indicating the photographable range shown in FIG. 5, and the mark 9 indicating the shutter speed were displayed on the display element 1 under a 5° C. environment. As a result of viewing the image display 10, the mark 7 was displayed red, the mark 8 was displayed black, and the mark 9 was displayed to be switched from gray to transparence. Of course, there was no case where a wiring pattern was viewed in an area other than the display portions.

### Example 5

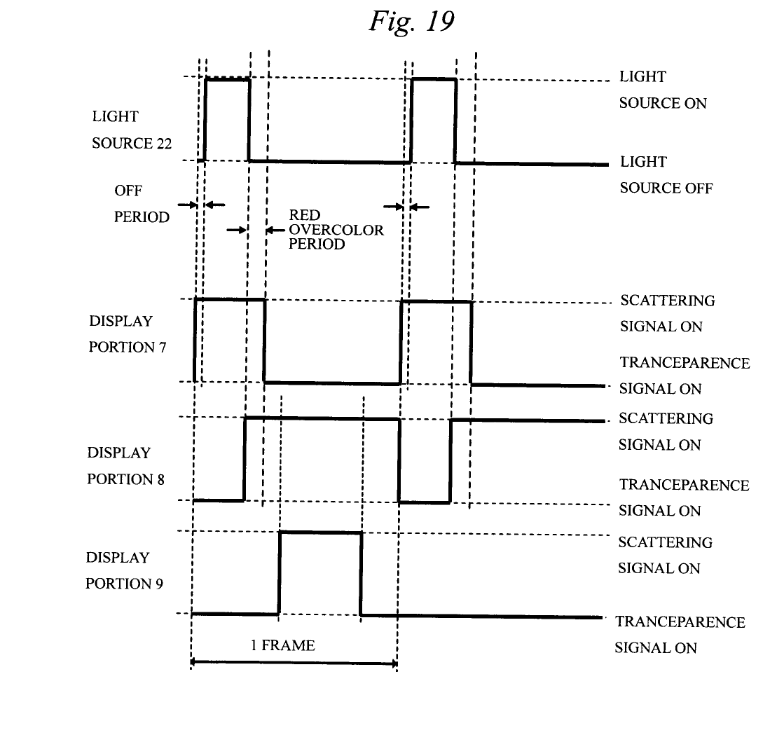

Similarly to Example 2, a display element in which a liquid crystal layer made of a liquid crystal/polymer complex was formed between the substrates was produced. A single LED light source of red (R) only was sued as the light source 2. The relationship shown in FIG. 19 was used as the relationship between the light source and the drive signal of the display element. The display portions 7, 8, and 9 have the same meanings as in Example 3. In this example, in a portion where red display is desired, that is, the display portion 7, light source ON is delayed later than the time of scattering signal ON, and at the time of light source OFF, the timing for switching the scattering signal of the display portion 7 desired to be displayed red to the transparence signal is delayed slightly later than the timing of light source OFF. When this happens, red and black can be mixed and viewed as perfect red. With regard to the display portion 8 desired to be displayed black, scattering signal ON may be made simultaneously with light source OFF. That is, similarly to FIG. 17, the light source turn-on period is secured, and a combination with scattering signal control is made so as to obtain good appearance of red by using color mixture. Here, when the frame frequency was 60 Hz. When the LED turn-on period was ⅙ of one frame, the OFF period was 1 ms, and the red overcolor period was about 2.8 m. In the same way of thinking as in Example 4, the OFF period and the red overcolor period can be appropriately adjusted in accordance with the balance between setting of the turn-on period of the LED in one frame, the response time of the liquid crystal optical element, and required appearance. When the frame frequency is 60 Hz, the red overcolor period has at a maximum of 2/6 of one frame. As the control circuit, any of the control circuits of FIGS. 7 and 16 may be used.

The display element 1 is placed as the display element of the image display 10 provided in the finder device for the camera shown in FIG. 4, and the mark 7 indicating the remaining battery level, the mark 8 indicating the photographable range shown in FIG. 5, and the mark 9 indicating the shutter speed are displayed on the display element 1 under a 5° C. environment. As a result of viewing the image display 10, it is observed that the mark 7 is displayed red, the mark 8 is displayed black, and the mark 9 is switched from gray rather than the mark 7 to transparence. Of course, there was no case where a wiring pattern was viewed in an area other than the display portions.

While the invention has been described in detail and with reference to specific embodiments thereof, it will be apparent to one skilled in the art that various changes and modifications can be made therein without departing from the spirit and scope thereof.

This application is based on Japanese Patent Application No. 2008-071614 filed on Mar. 19, 2008, the entirety of which is incorporated herein by way of reference. All references cited herein are incorporated by reference herein in their entirety.

### INDUSTRIAL APPLICABILITY

In the image display of the invention, two or more colors including black which are viewed beyond the eye lens can be produced simultaneously in an arbitrary portion of the display element. Therefore, display can be realized such that a non-display portion can be transparent and a background can be viewed.

1. An image display with a function for transmitting light from a subject to be observed, said image display comprising:
a display element which includes a pair of transparent substrates with electrodes and a liquid crystal layer which is sandwiched between the pair of substrates with electrodes and is capable of being in a light transmitting state and a light scattering state, the display element being brought into the light transmitting state when no voltage is applied and being brought into the light scattering state when a voltage is applied;
a light source which inputs light substantially parallel with a surface of the liquid crystal layer into the liquid crystal layer; and
a timing control circuit which brings at least a part of a display surface of the display element into the light scattering state or the light transmitting state in conjunction with the state of light emission into the liquid crystal layer of the light source in the presence of external light.

2. The image display according to claim 1, wherein the light source produces one light source color with a frame frequency of equal to or greater than 15 Hz.

3. The image display according to claim 2, wherein the light source color is red.

4. The image display according to claim 2, wherein the light source produces one light source color, the frame frequency of the light source color is equal to or greater than 15 Hz, a ratio of a light emission period in one frame is equal to or smaller than 1/3, and the timing control circuit brings at least a part of the display surface of the display element into the light scattering state in conjunction with at least a period of a light non-emission period to obtain a display color according to external light.

5. The image display according to claim 1, wherein the light source sequentially produces two or more light source colors, the frame frequency of each light source color is equal to or greater than 15 Hz, and the timing control circuit brings at least a part of the display surface of the display element into the light scattering state or the light transmitting state in conjunction with the state of light emission of one light source color or a plurality of light source colors to obtain a display color according to one light source color or a plurality of light source colors.

6. The image display according to claim 5, wherein the light source is capable of producing red, blue, and green individually.

7. The image display according to claim 5, wherein display in which the display color is a single color and display in which the display color is multi-color are performed at different display timing in a single display portion.

8. The image display according to claim 1, wherein a light guide portion is provided between the light source and the display element to spread light emitted from the light source from one end to the other end at the lateral part of the liquid crystal layer.

9. The image display according to claim 1, wherein the frame frequency of the light source color is equal to or greater than 30 Hz.

10. A finder device for a camera, comprising the image display according to claim 1.

11. An optical microscope comprising the image display according to claim 1.

12. Binoculars comprising the image display according to claim 1.
